(19) United States
(12) Patent Application Publication
(10) Pub. No.: US 2006/0294199 A1
(43) Pub. Date: Dec. 28, 2006

(54) Systems and Methods for Providing A Foundational Web Platform

(75) Inventor: Robert Dye Bertholf, Honolulu, HI (US)

Correspondence Address: HANSEN HUANG TECHNOLOGY LAW GROUP, LLP, 1725 EYE STREET, NW, SUITE 300, WASHINGTON, DC, 20006, US

(73) Assignee: THE ZEPPO NETWORK, INC., Honolulu, HI (US)

(21) Appl. No.: 11/423,843

(22) Filed: Jun. 13, 2006

Related U.S. Application Data
(60) Provisional application No. 60/693,451, filed on Jun. 24, 2005.

(51) Int. Cl. G06F 15/16

(52) U.S. Cl. 709/217

(57) ABSTRACT

A Web platform web-application framework in which functional block components are loaded as library elements at the time a website is accessed provides increased quality, accuracy and consistency of the website by enabling website management without a need for third party editors. Look and feel aspects of the website are loaded as library elements which are separate from content objects. Functional components stored as elements within a dictionary minimize redundant labor required to develop and deploy websites while providing extended functionality from a library of “plug and play” web components. Loading functional components as dictionary elements allows for seamless integration into the web-applications framework and other components. The web-application framework also identifies web visitor identifier information that is used to customize the displayed web page to the visitor's location.

This application claims the benefit of priority to U.S. Provisional Application No. 60/693,451, filed Jun. 24, 2005, the entire contents of which are incorporated herein by reference.

### BACKGROUND OF THE INVENTION

1. Field Of The Invention

The various embodiments are directed at Internet and web applications platforms, and more particularly at systems and methods for providing a foundational web application platform for rapid deployment of websites using plug-and-play modules.

2. Description Of The Related Art

Presently, Internet websites and web applications must be custom coded for each different technology and server platform. Various third party software products have been created to assist in such development, including for example, Microsoft Frontpage, Macromedia Dreamweaver, etc. Also, many content management systems (CMS) are available on the Internet or from vendors, which may be used as third party editors on the backend of a website. These efforts are narrow in focus and are specific to each market segment they target. These software products provide temporary remedies which only partially address the technological barriers facing the Internet today. To create a custom CMS, significant efforts by skilled application developers are required to generate new websites and applications. Much of this effort is associated with providing the interfaces between various pieces or modules of software to achieve proper integration.

Consequently, there is a need for more efficient assembly of websites and web applications without the assistance of applications developers.

### SUMMARY OF THE INVENTION

The foregoing issues and other problems with current website development can be overcome using the teachings of the various embodiments.

Various embodiments feature a web application including an application shell in which functional block components are loaded as library elements at the time a website is accessed by a user initiating a session. Look and feel aspects of a website are loaded as library elements which are separate from content objects. Assembly of such library components into the website script at the time the website is accessed enables easy and real-time web page development, customization and localization of the website and access to dynamic data.

In an embodiment, a web application for developing and presenting web pages includes a content module including at least one main segment content, an additional functionality module including at least one functionality component, a dictionary module including library element such as one or more of a navigation menu, a language menu, an administrative menu, a content menu, and an interface string providing interfacing elements for the at least one functionality component, and an application shell including software instructions for performing the steps of: initializing variables necessary to build the web page; configuring the web page; assembling content feeds using the initialized variables; and parsing in the content feeds from the content module, library elements from the dictionary module, and a functionality component to generate an ASP document.

The various embodiments may be implemented as a method performed by a computer system, such as a server, coupled to the network, software encompassing the methods, or computer readable storage medium storing software instructions which implement an embodiment.

### BRIEF DESCRIPTION OF THE DRAWINGS

FIG. 1 provides a general system diagram showing the major functional components of various embodiments of the present invention.

FIGS. 2A and 2B provide a functional flow diagram of the initialization and configuration processes of various embodiments of the present invention.

FIGS. 3A and 3B provide a functional flow diagram of the assembly and parsing processes of various embodiments of the present invention.

FIG. 4 provides a block and functional flow diagram of the components which make up a web page according to various embodiments of the present invention.

FIG. 5 provides a functional flow diagram of a process for building navigational array according to various embodiments of the present invention.

FIG. 6 provides a functional flow diagram of a process for parsing segments based upon a template specification according to various embodiments of the present invention.

FIG. 7 provides a block diagram of the various methods of editing and controlling a website according to various embodiments of the present invention.

FIGS. 8A and 8B provide a functional flow diagram of the process of integrating components and additional functionality according to various embodiments of the present invention.

FIG. 9 provides a block diagram of a system implementing various embodiments of the present invention.

### DETAILED DESCRIPTION OF THE EXEMPLARY EMBODIMENTS

Reference will now be made in detail to exemplary embodiments of the present invention. Wherever possible, the same reference numbers will be used throughout the drawings to refer to the same or like parts.

This invention provides a foundational Web platform that enables for rapid deployment and ease of maintenance of custom content-rich web sites. Enabling click-and-play integration of application modules, the foundational web platform provides for extending website functionality by selecting components from a library of installable web components which plug into the web-applications framework. This capability enables Web Managers with minimal or no knowledge of Web authoring languages, to develop and manage structured or unstructured content without third party software. Additionally, the web application provides international language support within the web-application's administrative control panel, referred to as the “Web Empowerment” area, as well as multiple language interfaces to individuals accessing the web-application, referred to as Web Visitors.

Developed to be a foundational platform that can be customized for the purpose of displaying and managing naturalized information on the web, the various embodiments of the present invention provide a web application that simplifies and automates the process of creating, authoring, editing and maintaining the structure, content, and functionality of a website. Providing scalable user management with custom permissions and dual mode management consoles. A user at any skill level can complete set-up and configuration of a website using the application as well as complete ongoing maintenance. This has significant benefits in terms of reducing the cost of ownership of online services, as web maintenance tasks do not require outsourcing development and management to third parties.

As a consequence of these capabilities, the various embodiments of the present invention provide the ability to: manage all unique client data in centralized databases; rapidly deploy application from host server to client directory utilizing a “build blueprint” of the web application shell and web components; deploy updates seamlessly without loss of client data; manage product license and valid dates centrally in host server database; and create and manage file and database structure from host server.

The processes and capabilities of the various embodiments are enable by breaking the concepts and steps of web design and development down into a science. In this analysis, it was determined that web management and deployment involves eight major areas of activity or computation: Content Management; Access Management; Appearance Management; Identity Management; Settings Management; Maintenance; Library/Media Management; and Extended Functionality/Component Integration. The various embodiments identify and group all related tasks into these areas of activity, providing data structures and methods facilitating the related computations.

In regards to the Web Application, the various embodiments of the invention provide the ability to: use and manage preset global functions through Application Shell and Web Components; connect to multiple database types: MS Access, mySQL, MS SQL; automatically or manually select Mail Component based on available server components; automatically or manually switch to local translation of language/dialect; hold all text in dialect specific language cards for ease of localization; automatically filter foul language out of web visitor inputs; display custom error messages to web visitors upon errors such as 404 requests; collect and report on visitor navigational patterns; dynamically adjust the web applications navigational system based on visitor trends; display custom MetaData for the Application Shell as well as for each page translation; operate out of root domain directory or subdirectory; run multiple websites off of same domain sharing one application shell; host with Secure Socket Layer (SSL) certificate; restrict access to selected documents and administrative area; control access based on permissions specific to individual logins; collect and log information pertaining to suspicious web activity; reject access based on Cookies, specific IP Address or IP Address range; localize web experience to include Dialect Selection, Currency Conversion, Date Formatting and GMT Offset; navigate through various menu types; interact with various pre-build components, such as Site Search, etc.; and select Printer Friendly versions of each page.

In regards to Application Management, the various embodiments of the invention provide the ability to: create and manage site navigation to include subordinate navigation menus; create and manage multiple translation pages for each navigational item; manage website template and template skinning throughout the website; develop and apply template skins within the web application; manage scalable user logins and administrative permission control; and create and manage multiple custom web identities.

In regards to Extended Functionality, the various embodiments of the invention provide the ability to: select, purchase and install additional functionality from web maintainers website; configure, activate and deactivate additional functionality; have executive overview of multiple web components statistics and pending tasks; and create custom component interfaces to be used by web visitors.

Just as the personal computer has an operating system, various embodiments of the present invention provide a foundational platform for web and Internet applications pre-developed to setup and manage components operating within a shell to provide a website. This standard platform is dynamic enough to facilitate development and flexible enough to allow for complete scalability. With focused efforts on web empowerment within the platform, components developed to plug into the existing framework provide websites developed using embodiments of the invention with extended functionality with no additional development required.

The Web application may be accessed utilizing a standard web browser and multiple users may access unique tasks within application simultaneously. Thus, the Web Manager does not need to know the HTML programming language to access the application to manage content, create new pages, process content through workflow, and define website and content style.

The various embodiments may be described herein in terms of the application shell, functional block components and various processing steps. It should be appreciated that such functional blocks may be installed via the web in an automated fashion and quickly configured to perform their specified functions. The various embodiments include two different scenarios, one where a web visitor/Web Application user visits (i.e., accesses via a web browser) a website implementing an embodiment to view a desired web page, and another where an administrator builds or manages a website using a Web Empowerment control area which enables customization. A user can also visit a website that was developed using an embodiment and be able to see custom content that was specified by the website developer and is served up by the Web Application.

The main application shell is a flexible, scalable, and dynamic environment whereby a foundational web platform is created. The Web Application Shell refers to the core files and components required to run the web application according to the various embodiments. Within this platform, all basic functionality, including template, content, and website structure, are managed, database connections are established, and server/mail components are initialized.

While the application shell is sufficient to generate and manage a basic website, additional functionality in the form of various block components is available for installation into the web-application from the Component Manager. When a component is installed, an embodiment of the present invention builds the file and data structure from the respective component blueprint found on the Host Server.

Page assembly occurs when a Web Visitor accesses the web-application. During this process, page navigation is generated, roles are identified and permissions are set, template format and style are loaded, placeholders are identified, and language cards are loaded. Then the language segments and content and components alike are parsed into their designated areas.

An important aspect of website development involves creating and managing the website's appearance to affect the entire or specified portions of the website. The various embodiments of the present invention facilitate this task by providing greater flexibility to the generation, use and modification of templates. The aspect of various embodiments which enable a Web Manager to generate, us and modify templates is referred to herein as the “Web Empowerment Module.” Within each template grouping there may be a single or multiple layouts and/or designs that may be applied to enhance the user's experience. Skins also are assigned placeholders to identify where the requested content and components should be parsed in during page assembly. A unique global style sheet defining the website's visual appearance is assigned based on the current template. These web skins and style sheets may be created and managed within the web-application via the Web Empowerment Module.

In addition to the main page (default.asp), an unlimited amount of additional web pages may be created within the base path of the web-application or sub directory therein. Each page is provided a unique uniform resource locator (URL) based on the page's initial title. Pages may be broken down into two main categories, one of which is visible or accessible within the main menu, and the other which is only accessible if linked to internally or externally. Pages may be assigned a Parent URL, automatically structuring them as a subordinate page within the dynamic menus and site maps. Each page may be assigned multiple language sets, as described below, where the web manager may include translated content copy. In addition to the page content assigned to each language set, there may be assigned multiple content and component segments for each language set. Content segments allow for additional text copy to be included where specified in a web page. With various embodiments of the present invention, component segments may seamlessly integrate content and components by providing the ability to interface with installed components within a specified web page. Both content segments and component segments share the segment block identified within Template management.

The flexibility in templates, language cards and library components enable the website to have language and content variations. Additionally, the various embodiments support different types of structures within the related Menu placeholder, including Horizontal Menus, Vertical Menus, isolated Sub Menus, and Vertical Menus with combined Sub Menus.

The Web Empowerment module allows for both a Component/Tasks status overview area as well as dual mode web application management. Both, completely integrating the application shell, any installed components, and/or linked websites. Dynamically generated based on permissions within the application shell and installed components, a Component/Task Status overview provides a status of pending tasks with easy to access task initiation. Specifically designed with the expert web maintainer in mind, Dual mode Web Application Management allows for every aspect of the website to be tweaked and modified. All the applications variables are accessible within the Web Empowerment module control area so even the most skilled maintainer would not be limited by this web platform. Another mode within the Web Empowerment module control area, created for novice users, empowers individuals with little or no knowledge of the web to setup and maintain the application. This mode breaks down condensed management tools assigning default values to most application variables, less choices, and more detailed descriptions for each web option. In addition to the ability to select specific management tasks in the Web Empowerment module control area, the user may be guided step by step through many of the processes using easy to use walkthroughs. These walkthroughs are not only designed to better aid the new web maintainers in setting up their web application but are also designed to provide a better awareness of web applications, the internet and processes taking place by instructing the maintainers. Optional tutorials are also available within the application shell which better explain how web systems such as the internet function as a whole and also specific to various web tasks.

Various embodiments of the present invention permit Web Visitor Localization to allow customizing generated websites according to the visitor's location, nationality, native language and selected URL. This capability allows web visitors to quickly and easily view web content in their local format. Locale formatting functionality includes date formatting, currency conversion and format presentation, language and other localization settings. Locale customization is expanded to include the control panels used for site creation and management in the Web Empowerment module, providing Web Managers with a comfortable and naturalized environment for managing their website. During the initial setup, the Web Manager is able to select the web applications default country, date format, currency and even their local dialect to ensure maximum performance. Additionally, the Web Manager is also able to manage which languages their website specifically targets and can create translated content for each dialect.

In addition to numerical LCID codes, various embodiments of the present invention also support the referencing of locales by means of three-character Windows locale codes and two-character ICANN Top Level Domains (TLDs) codes. Since there is no exact relationship between locales, dialects, currencies and TLD codes, embodiments of the present invention incorporate a relational table which can be controlled from the host server level. This embodiment standardizes the relationship between countries and currencies, dialects, Top Level Domains, and date formatting from the host server level.

Localized dialects of a Web Visitor may also be supported within various embodiments of the present invention. In many countries, the native language may be a distinct dialect that differs significantly from the national language. Thus, the ability to localize the website to particular dialects is expected to enhance the economic power of commercial websites. The web visitor will see a direct translation or may also have the ability to select their language if configured in the web application.

Quite often the Web Manager employs a hosting provider that is located in a different time zone. Because of this, tracking web activity based on date timestamps can become quite confusing. To solve this problem, various embodiments of the present invention support a Greenwich Mean Time (GMT) Offset function which will convert all dates to the localized settings of the Web Manager. This functionality may be extended to provide the proper date/time for the locale of each web visitor, with date and time presented in the proper local format.

Content to be displayed or accessed on the website is stored in a tree-structured format database, thereby allowing ease of navigation, searching and modeling of graphical relationships between sites and content. Within the foundational Web platform provided by the various embodiments, the content is maintained separate from the template design (i.e. look and feel) of the website. Using templates ensures that the appearance of pages throughout the website is consistent and meets the branding standards. This architecture also allows publishing of the content in different forms and formats. For example, the same content can be used in Flash, HTML and other versions of the site. Another benefit of using the template-based model is that it allows a site to be reconstructed in seconds, giving the client control over the content of their existing site. Tree-structured content and the flexibility to apply multiple categorizations to articles/pages are very useful for providing access to and use of metadata. Using various embodiments, Web Managers can specify any metadata fields to include in custom keywords using the Web Empowerment module.

Other capabilities of various embodiments include the following. Unlimited users can be created and assigned to groups. Access can be disabled for a user or it can be scheduled for a specific period of time to be expired. The site will automatically scale itself to support one login in a personal website setting to multiple users in an extranet setting. System administration can assign unique permissions to every individual user. Every single activity within the standard application is logged. System Administrators can trace down every user that has logged on to the system and generate a report with every action done. The standard application is protected with a username and a password. In addition, the application can restrict access from every IP (i.e., from 0.0.0.0 to 255.255.255.255) and allow access only to specific IP or IP range. (i.e., allow access from 194.154.0.0 to 194.154.255.255). This ensures advanced protection of a website and content.

The application shell may come standard with many built in functionalities typically required for a website presence. Typical built in functionalities may include a Site Map, Advanced Site and Document Search, Contact Forms, Website Statistics, Multiple language selection, Meta Data assignment, Word Filter, IP Restrictions, outgoing link validator, Terms of Use/Privacy Policy Generators, and ability to export the website to HTML. Additionally included with the application shell may be a wide range of components that provide extended functionality to a website. All components integrate seamlessly into the Application Shell and most include the ability to create custom Web Visitor interfaces on the fly. Examples components contemplated as part of this invention include the following:

Guest book

Article Manager

Real Estate Management

Customer Relationship Management

Contact Management

Electronic Communication Manager

Banner Management

Property Management

Poll Management

Event Management

Image & Media Management

Project Management

eCommerce / Shopping Cart

The capabilities described above are enabled by the various embodiments, which are now described with reference to the figures.

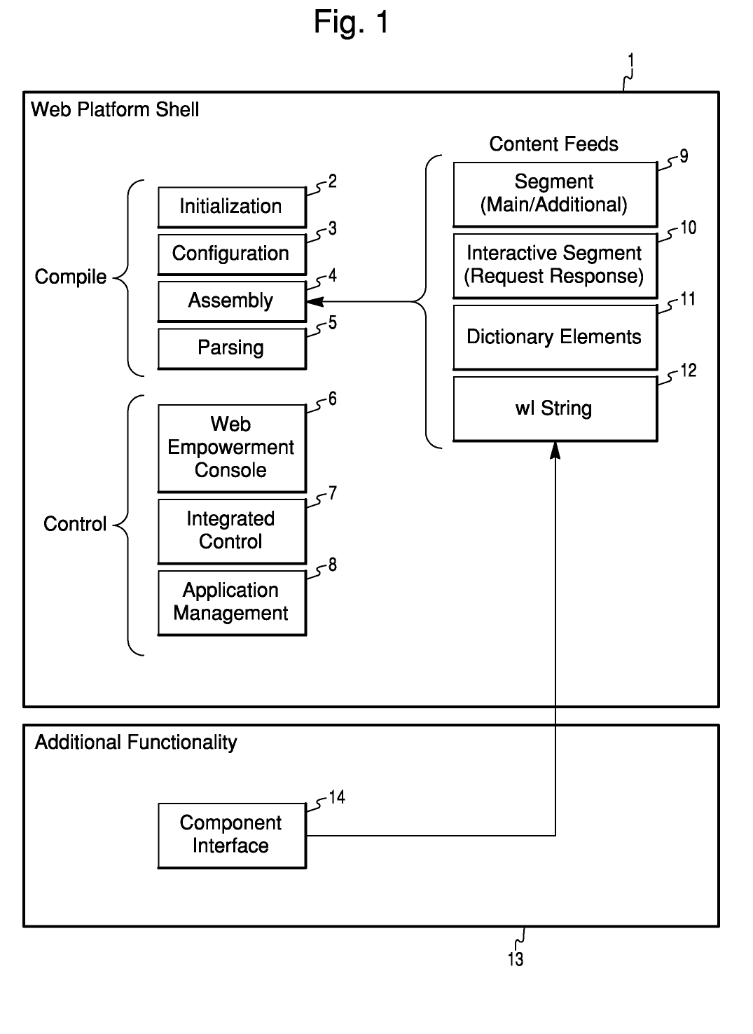

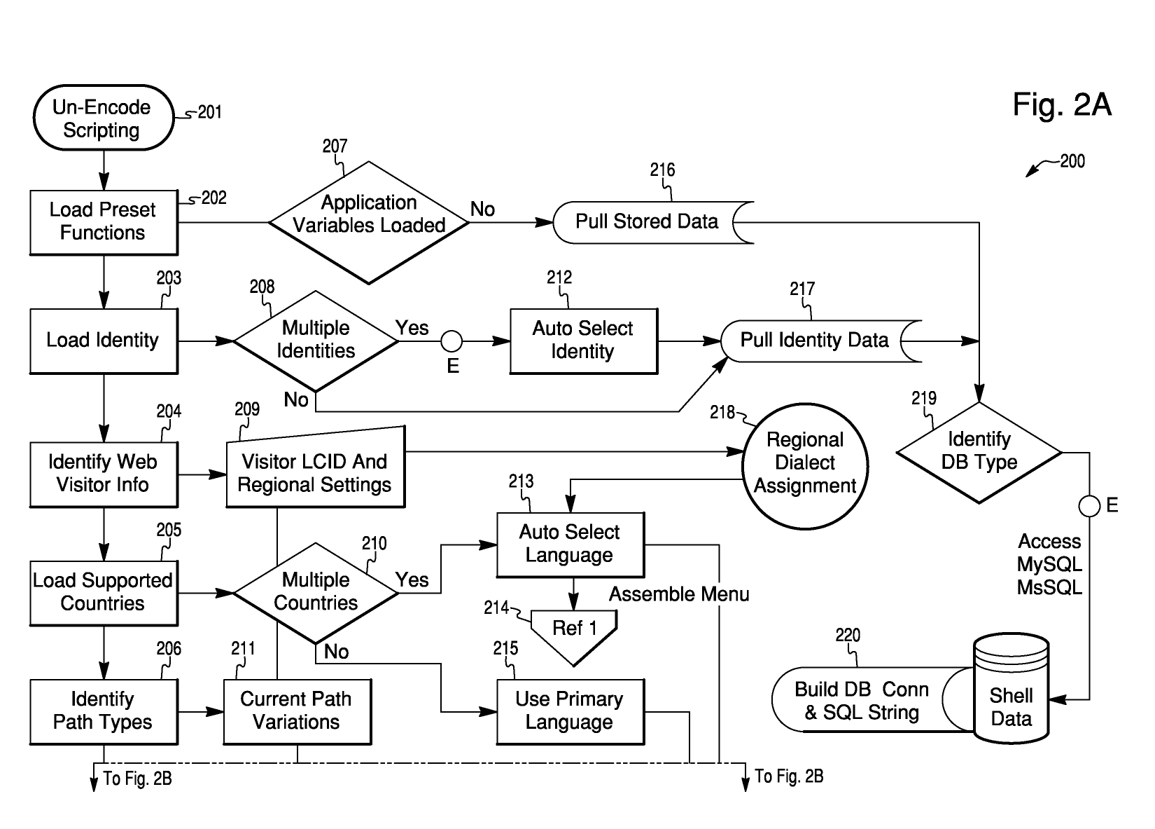

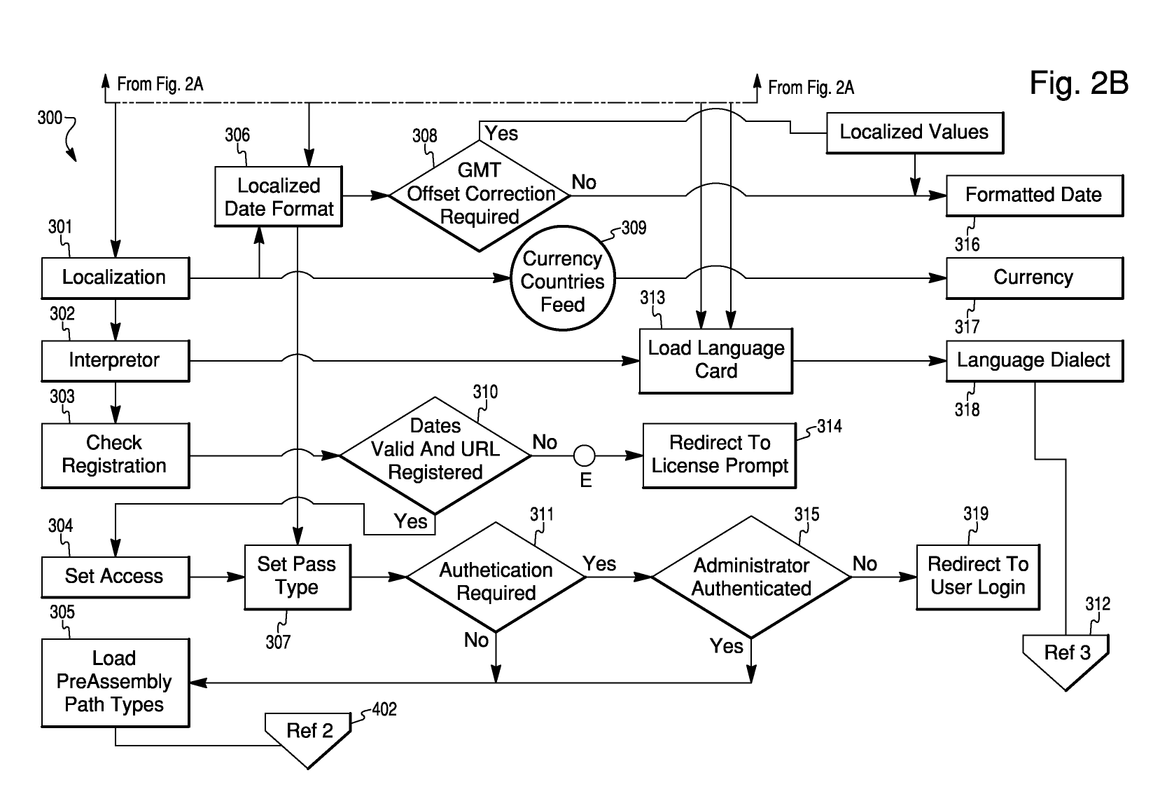

FIG. 1 provides an overview of the components and relationships of the foundational web platform provided in various embodiments of the present invention. The foundational web platform involves two operational pieces; compiling the content and controlling the assembly. Steps 2-5 illustrated in FIG. 1 involve the construction of the framework; menus, look and feel, and outside elements. To these operational pieces are added the content to be displayed on the website. The operational framework for the foundational web platform is referred to as the shell 1. Within the shell 1, the first operation conducted when a web visitor access the website is initialization 2. In initialization 2, the shell identifies information about the web visitor, essentially figuring out from where the web visitor is accessing the website. Initialization 2 is performed to load in application variables when a person first contacts the website or moves to a new page, and some of the initialization steps may be skipped if the information is on hand within the shell or accessed data files. During initialization 2, the shell 1 begins preset functions, web functions (e.g., touching databases, determining the query type, ordering date, etc.) and processing scripts to manipulate data. During initialization 2, the shell determines which of multiple web identities is being accessed by looking at the entered URL. In this step, the shell grabs server variables, visitor variables, identifies all the elements, determines where the piece is located, identifies the necessary databases, and identifies the regional settings. Further description of the steps performed during initialization 2 are provided below with reference to FIGS. 2A and 2B.

Once the initialization step 2 has obtained the variables necessary to build the website, the configuration step 3 begins working with the variables. During the configuration step 3, the shell interprets web visitor language selections, configures language cards, validates the URL for the site, and checks and sets the access levels granted within the site to the web visitor.

Once configured, the shell then performs the assembly step 4 to begin building the page using the identified and configured variables. In the assembly step 4, the system generates a generic structure that captures the desired “look and feel” of the site, ensuring that all of the pages look similar and feature common menus and navigation tools. Current web development tools support look and feel creation by allowing the developer to define where pieces appear and create a template that masks over the page to create a generic structure so all pages look the same. In contrast, various embodiments of the present invention enable the elements to be built into the template as the website developer asks them to be using the Web Empowerment module. This option permits the developer to start page development effort with the look and feel of the site. The Web Empowerment module integrated console 7 allows creation and editing of the web page by dragging and dropping pieces since the template is assembled after the system selects the elements that will be placed in the page.

In this step, the shell builds into “blocks” the dictionary elements 13, which are elements held in a dictionary store from which each dictionary element 13 can be pulled. Generally, dictionary elements 13 store the data and HTML code elements that contribute to the look, feel, and functioning of the website. Different navigational utility types are stored as menu elements which are a type of dictionary element 13 that is stored within the dictionary. Dictionary elements are built out one time and can be called as needed. Menus are built out upon the visitor load, that is when a visitor first visits the website, and the system then fills out the menus depending upon where the visitor navigates through the site. If the visitor's actions change any element set during initialization, the system will need to rebuild the menus. Otherwise, the system will draw menu dictionary elements 13 from the dictionary.

Dictionary objects provide the website developer and owner with greater flexibility in providing menus, borders and other look and feel elements of a web page. Rather than the developer having to go into the Java script file to build out the file, as would be required in current web development practice, various embodiments of the present invention permit a web developer and site owner to simply direct the system to build the outputs file from the dictionary. The developer simply indicates the appropriate dictionary object (i.e., the object's file designation) in a string format. The developer can allow an object, such as a Flash document, to look for an element with which it is compatible within the dictionary, rather than having to generate out independent menu dropdowns. The system enables objects to determine which elements with which it is compatible, so the developer only has to select the object and allow the system and the object to obtain all the information the object needs. This capability makes it possible to give websites multiple uses.

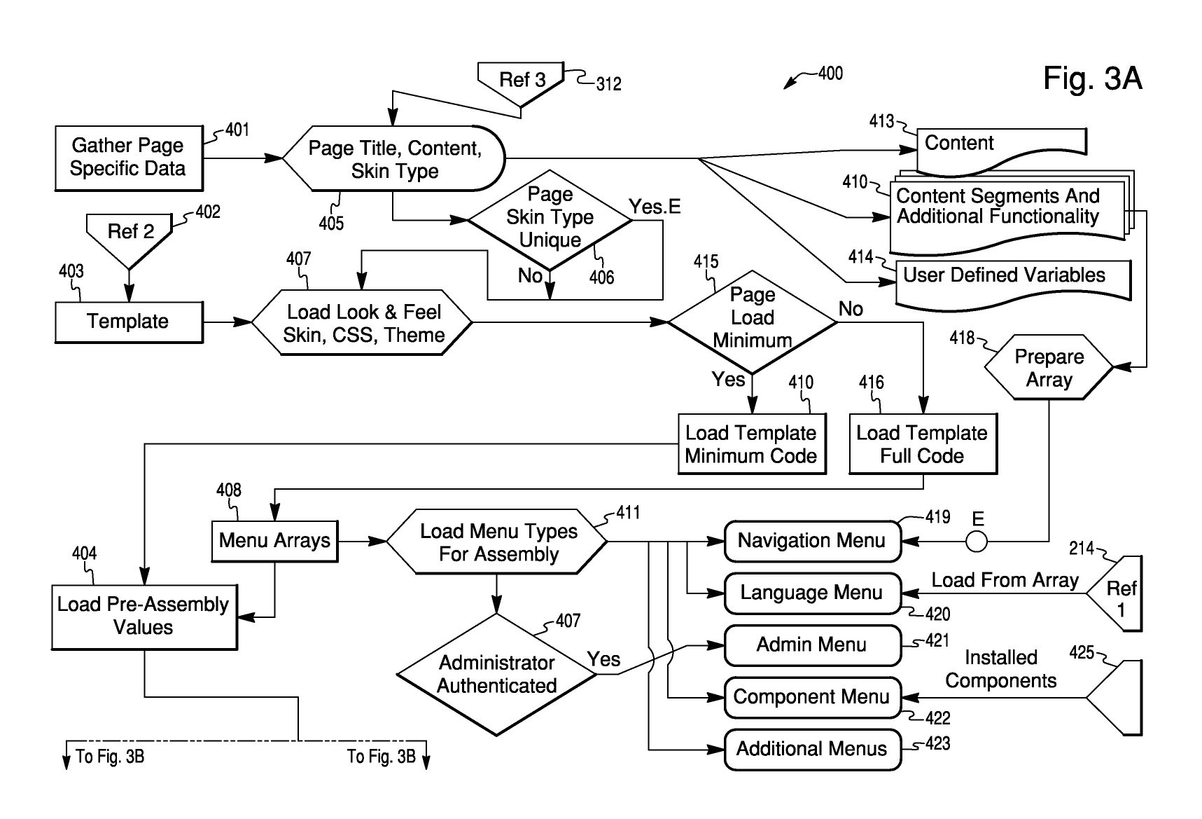

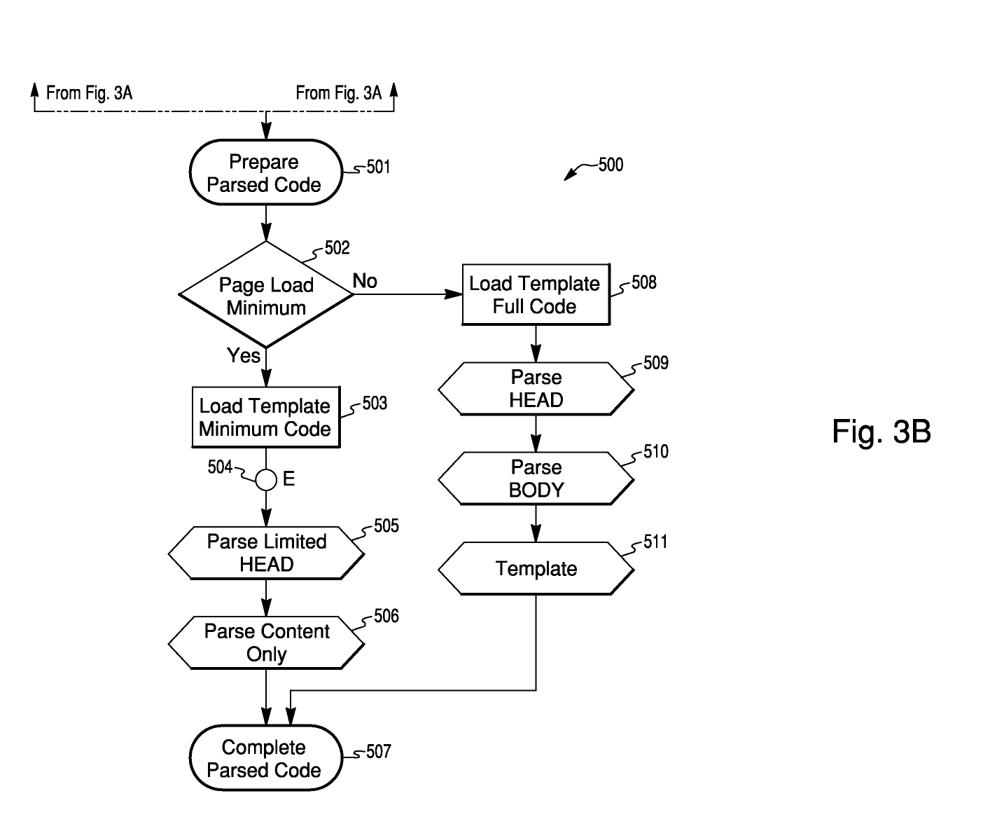

The system accommodates a variety of content types which are fed into the assembly step 4. The variety of content feeds are illustrated as items 9-12. The specific steps for integrating the content feeds are addressed in FIG. 3A which shows the assembly 400 in more detail. These four content types provide the content displayed on the site. Content refers to data that is pulled from the database for display on the generated web page.

Segment 9 stores the main content of the web page, e.g., text and photographs. A web page may have just one segment, which is identified as the main content. However, commercial web pages increasingly feature multiple areas of main content displayed in different portions of the web page as web managers seek to provide greater utility and greater information in easy to use formats. To support this, the system accommodates multiple content segments which can be positioned in different regions of the web page. The system will accept an unlimited number of different content segments. Generally, these are segments that are declared as holding static content that is dynamically pulled from the database during the assembly step 4.

A second type of content feed accommodates interactive segments 10. Interactive segments 10 are dynamic content elements which are pulled from an appropriate database dynamically. Unlike the static content of segments 9, which contain a block of text or images stored in memory, interactive segments 10 comprise a data request to a dynamic database that loads the response data in the specified location on the web page. Interactive segment allows two different data sets to be displayed for two different visitors. The data may differ based upon the time a visitor accesses the web page or may differ based upon other information unique to each visitor, such as visitor identification. Typically, a web developer must hard code the interactive segments into the template. In contrast, the system of the various embodiments of the present invention permits loading the interactive nature directly into the segment that is parsed into the website page at the time the website is accessed. Including an interactive segment 10 on a website page enables a web visitor to request dynamic information, i.e., information that may be changing and is maintained in a database that is separate from the website, and receive a response on the page that contains the current data.

As an example, an interactive segment 10 may be a List The Top 10 data request which includes a query to a database and formatting information for presenting the response data. A List The Top 10 segment addressed to a press release database would display a list of the latest ten press releases. Since press releases may be issued at any time, using an interactive segment 10 and a separate press release database ensures the latest press releases are displayed without the need for daily updates to the website. The Request and response of an interactive segment 10 can be in the same area/segment of the web page. Typically, the interactive segment 10 is implemented when a visitor hits the site, which causes the system to access the database and post the response data in the position on the page indicated for the segment. Alternatively or additionally, an interactive segment 10 may be user activated, so that a web visitor may click on a button or portion of the window to cause the interactive segment 10 to access the database and display the latest data responsive to the segment.

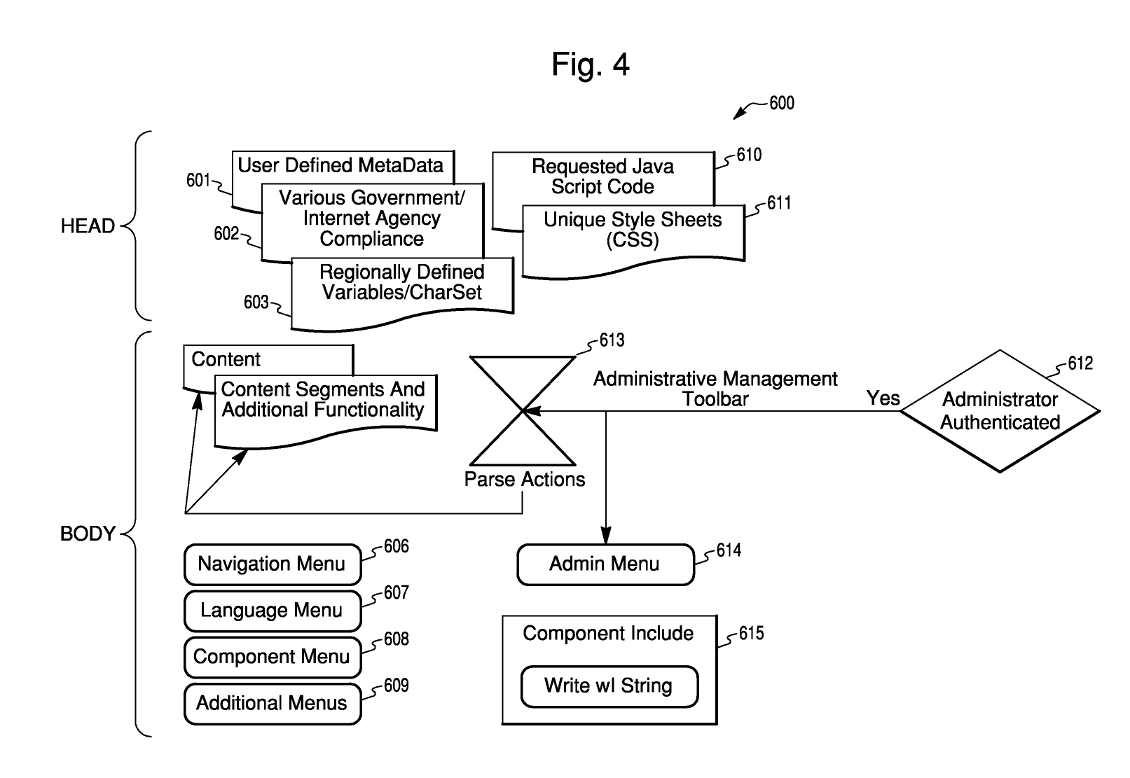

As discussed above, dictionary elements 11 are the various pieces for menus, meta data, style sheets, and other pieces that make up and help to provide the look, feel and functionality of the web page. Dictionary elements 11 are discussed in more detail below with reference to FIG. 4.

The fourth type of content feed is referred to as wi strings 12. Each wi string provides the HTML interface for additional, plug in additional functionality 13. Additional functionality 13 components are “plug and play” software modules which the system is designed to accommodate with minimal changes to website design and software. To accomplish “plug and play,” a wi string is used as a content feed to provide a software interface for the assembly step 4. An example of a “plug and play” additional functionality 13 would be a guest book module which may be a standard module that can simply be added to a website without a need for creating the module from scratch. The wi string provides the customizing parameters to fit the guest book module into the website with the same look and feel as the rest of the web page. During the assembly step 4, the wi string is parsed into the web page, which brings in the additional functionality of the guest book module. Basically, the wi string snaps into the web shell, but is not part of the shell, i.e., it is not a physically required element. Further details on wi strings 12 and the implementation of additional functionality 13 are provided below with reference to FIG. 4.

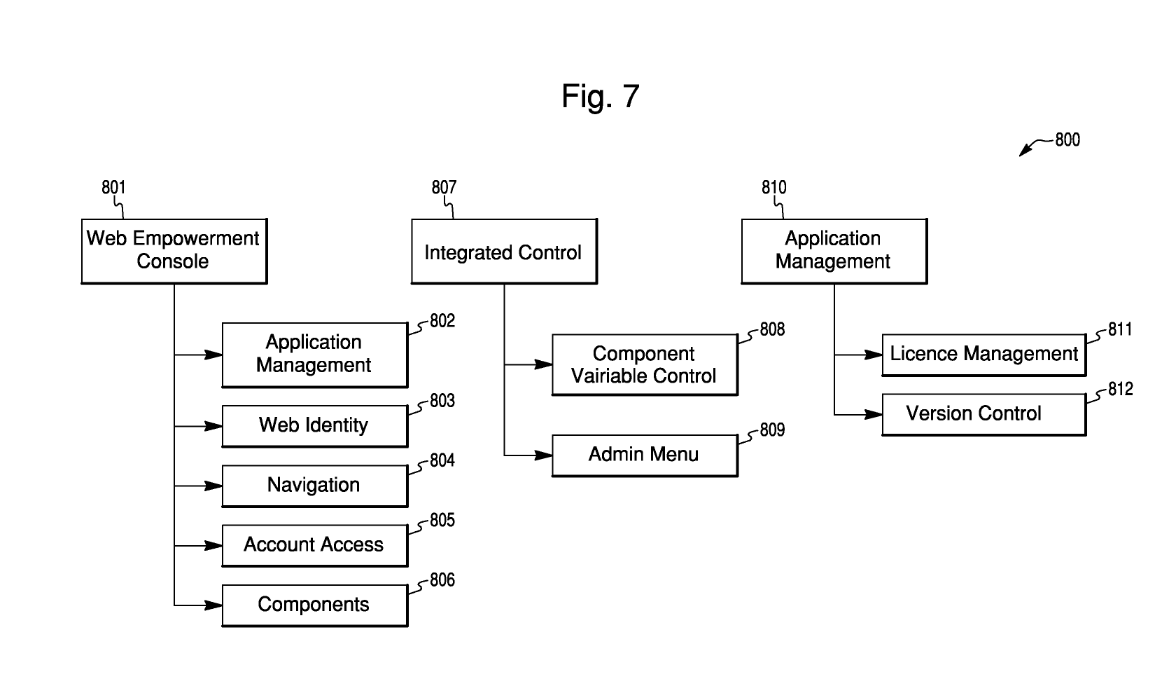

Continuing to refer to FIG. 1, the Control elements 6-8 are functionality provided for the website owner. Web Empowerment module console 6 is the main user interface for remote for control of the website from the backend. A website owner seeking to make significant changes to a website can log into the website and use the web Empowerment module console 6 to make any changes to the website. The Web Empowerment module integrated control module 7 is a unique aspect of the system which allows a website owner to make changes in arrangement and content while the website owner browses through page, providing editing menus appropriate for each type of content indicated by a pointing device (e.g., by “mousing over” a segment or object, or clicking on the segment or module). When a website owner logs in, the system recognizes the administrator and provides editing menus via the Web Empowerment module for controlling the website content commensurate with the visitor's individual access permissions. The third control element of the Web Empowerment module, application management 8, provides the system software provider with access to and control over those portions of the website data needed to enable software updates, use monitoring and license enforcement. The applications management 8 capability allows management of software licenses, version control and allow updates. Further details on the control elements 6-9 of the Web Empowerment module are provided below with reference to FIG. 7.

As mentioned above, additional functionality 13 are preprogrammed modules or components that can be added to a website by simple point and play implementation. The system shell enables setting up menus and creating structure and content to provide a complete website from scratch. To enable faster site development, a website owner may also plug-in additional functionality without having to generate it. Examples of additional functionality 13 modules include a FAQ—frequently asked questions—module and a customer relations manager—CRM—solution module. A website owner can implement either a FAQ or CRM solution by simply selecting it and providing additional content associated with the solution (e.g., as the particular questions and answers for display by the FAQ solution).

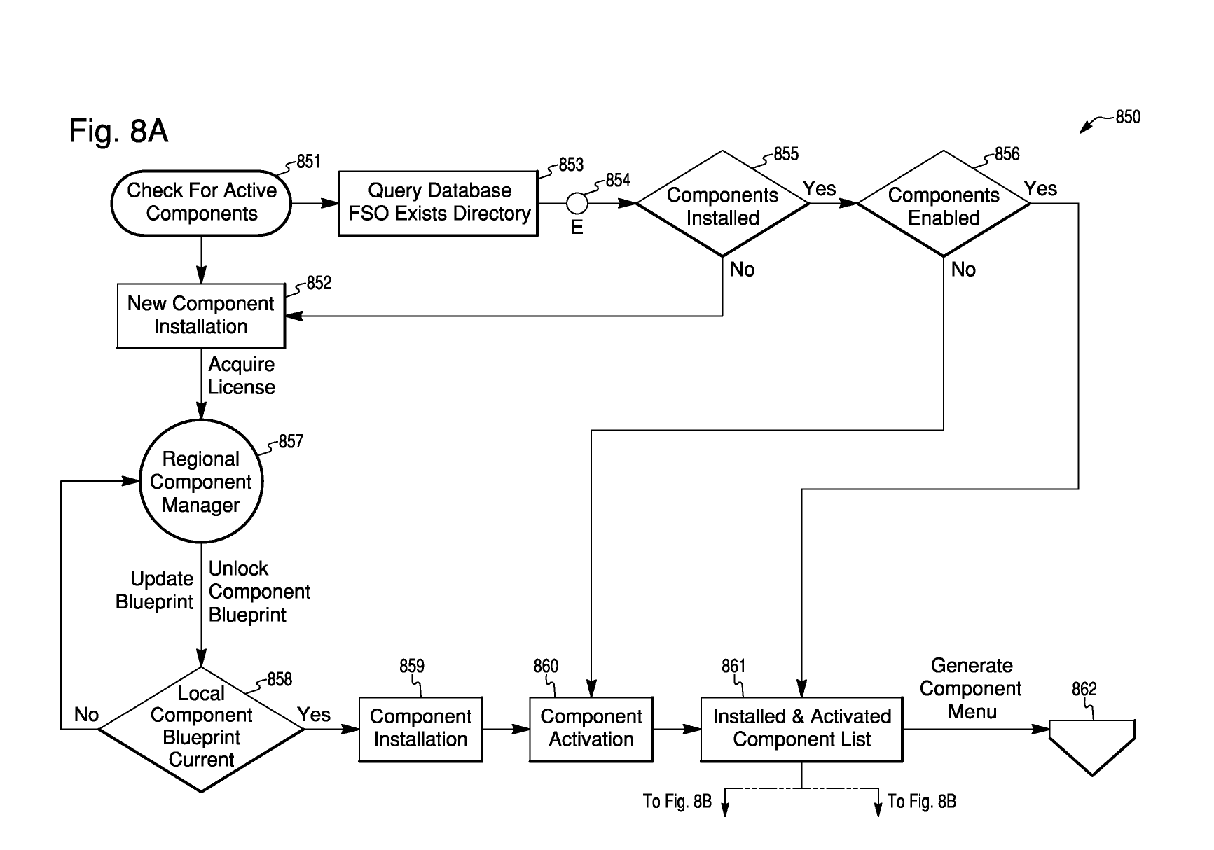

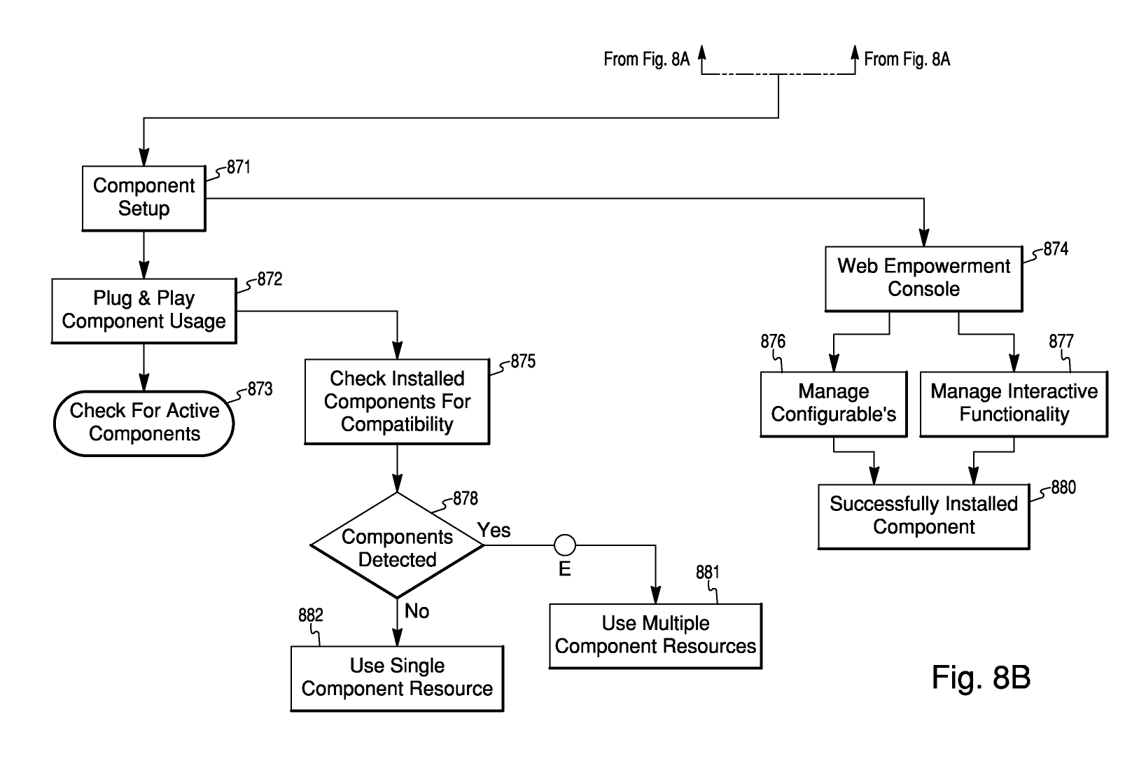

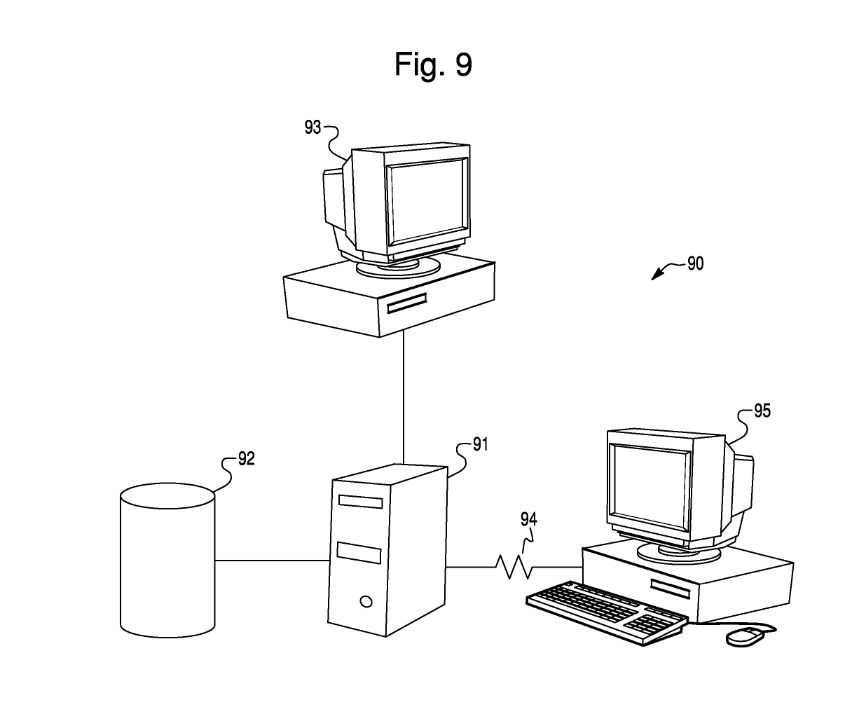

The various embodiments permit implementing additional functionality 13 at multiple levels. Referring to FIGS. 8A and 8B, the system features the ability to identify if a particular functionality component is installed, and if not, permits the site owner to install it, such as by purchasing a license and downloading it from a developer's website or an on-line catalog maintained by the system provider. Once installed, an additional functionality 13 is identified as available to the system. Additional functionality 13 components are to be developed based upon a blueprint that specifies the interface details necessary to create objects compatible with the system disclosed in the various embodiments. In this manner, developers can embrace the system shell to build their own additional functionality objects which can be implemented as “plug and play” modules that integrate with the system that is the subject of this invention. Additionally allowing outside developers to build component blueprints; these documents are read and executed by the application shell allowing for the databases, tables, fields, and pages to be generated plugging into the application shell. Because functionality objects do not have to be hard coded into the shell, thousands of different components can be built and modified by third party software providers without changing the basic system or the website development code. This enables websites created under various embodiments to be global products that can be readily modified and expanded in functionality.

Referring to FIGS. 8A and 8B, to install an additional functionality 13 module, the system checks to see if the latest build of the blueprint is installed in step 852. If so, the system takes the blueprint and an element of the shell looks at the data for component, administrative elements, and the interactive elements of the component and builds it out. Then at 870, FIG. 8B, the system sets up the component by applying the customer values to the component—like typing in the questions in the FAQ component in a back end GUI for that component in the set up process. Once in place, the user can activate it. Activated, it builds itself as a dictionary element, builds itself into the component menu within the template. Once installed it can be browsed easily. FIGS. 8A and 8B illustrate the administrative side of the system. Use of the component varies based upon its use.

Returning to FIG. 1, after the assembly step 4, the system performs the parsing step 5, which accepts the assembled code and parses present and activated dictionary elements 13 into the template. This process generates the HTML code in the ASP document which displays the localized data to the visitor's web browser that constitutes the website.

The various embodiments encompass both the shell 1 and the additional functionality 13 enabled by the shell 1. In an embodiment representing a minimal configuration, the shell 1 can provide a standard web presence, namely web pages providing displayed content along with the “look and feel” of the pages, menus and navigation tools.

In an advantageous capability provided by various embodiments, the initialization process 200 shown in FIG. 2 can be configured to obtain an identifier for the web visitor which permits the assembly 4 and parsing 5 steps to build a web page featuring a custom presence (i.e., specific or unique “look and feel”) for that particular visitor. This option permits localizing the site for the particular web visitor. Obtaining the visitor identification (ID) may be by means of any number of identifying information that relates to an aspect of the visitor for which website customization may be provided. Examples of visitor IDs described more fully below include the visitor's geographic (e.g., country) location, native language, native dialect, computer ID (e.g., by a cookie identifying the computer as a prior visitor), license ID and personal identity. Other example visitor identifiers contemplated within various embodiments include navigation link information (e.g., the link path that lead the visitor to the site), operating system type and version, computer make and installed components, session ID, and other identifiers that provide information useful for providing a customized web experience to the customer. An embodiment permits a number of uses of the visitor ID values. In a preferred embodiment, location and nationality data may be used to generate a website in the visitor's native language and dialect, presenting currency values in the proper monetary units and format, presenting number, date and time fields in the proper local format, and providing accurate local time (i.e., date and time data in the time zone of the web visitor). Aspects of the various embodiments which permit such localization and customization are described in more detail herein.

With reference again to FIG. 1, another advantageous capability of the various embodiments is provided by the additional functionality 13 portion of the system is the ability to streamline the development of complex commercial websites. Using traditional web development tools, a web developer would have to build up the various functional pieces with the website running over the top of it in order to get all the pieces to talking to each other. Typically, this process may take 3 months to complete. The additional functionality 13 capability of the various embodiments enables a developer to get the various pieces talking to each other within minutes. This is accomplished by enabling components to recognize compatible (like/friendly) elements available in other installed functional component and to select a single like/friendly element to use for all components. For example, if the website has a newsletter component installed, that component will provide the functions of sending correspondence to a subscriber list (e.g., e-post cards) using a mailing list element that is part of the newsletter component. If the website also has a contact relations manager (CRM) component installed, the newsletter component will recognize that it can work with the contact address file element within the CRM component. In other words, the newsletter component recognizes that the contact file element in the CRM component is a like/friendly element that can be shared. Looks for like-friendly components. A prioritization scheme allows the various components to determine which of the various like/friendly elements is to be used by all components. This prioritization scheme ensures the most capable or best maintained element is used consistently. In this example, the CRM component includes the most capable contact database function. Therefore, the system ensures that all additional functionality 13 components which require a contact address data base use and maintain the sophisticated CRM component's contact database.

This capability of allowing functionality components to identify and share a single common element avoids the need for redundant data files (along with all the problems of having to maintain and synchronize redundant files) while helping to provide a single user interface and consistent look and feel.

The capability to recognize and use like/friendly functional elements of other installed functionality components is provided by means of a database file that holds all of the databases (see blocks 219-220). Rather than accessing a database directly, the system accesses a list of the different databases that are installed and available on the website. This database access occurs the first time a visitor accesses the website. During initialization, the system checks to determine which of the available databases are installed and connects appropriate functional components to them. The list just contains the available databases. The use of a list of available data bases permits rapid changes and upgrades. For example, if a website owner wants to upgrade to a SQL server, the owner only needs to change the database listing in one location, namely the list of available databases, rather than having to modify HTML code throughout the entire website.

Returning to the example discussed above, a website having both a newsletter component (which provides a communication function) and a CRM component installed, will have data stored in a MUX table that lists the interactive elements (i.e., the requests and responses) of both the newsletter and CRM components, and identify the friendly elements that each functionality component can interact with. Then, to send an e-news letter, the newsletter component would see in the MUX table that there is an alternative installed address data source available in the CRM contact list element. The MUX table would also indicate a relative priority indicator for each friendly element which allows the various functional components to determine which element to use. In this example, the MUX table would include data indicating that the CRM contact list element has a higher priority than the address list element of the newsletter component. Thus, the MUX table will include interactive details, like/friendly data and a priority data of shareable functional elements that the code of a functionality component can reference to identify every functional element that the database has to offer that particular component.

The ability to offer common functional elements, referred to herein as “global functional elements,” to all components installed on the website enables another enables another new and advantageous capability—providing a common word filter for the entire website. Word filters for particular functions have been employed to identify and react to certain categories of desirable or undesirable words, such as foul and obscene language, within particular components. However, each component having a word filter required its own dictionary and word recognition software, imposing an excessive memory and processing burden to deploy word filtering for every component active on a website. The various embodiments permit a single, common word filter functional element to be used for all components and functions on the website. Such a word filter will recognize any undesirable words entered in any portion of the website and take the appropriate action, such as censure the words. Using a master word file and a global word filter function saves memory and speeds the operation of the entire website.

Another example of a global functional element is one that performs the task of checking domain names to confirm they are authentic. Thus, no matter where on a website that a visitor enters a URL, the same functional element is used to confirm that the URL is legitimate and in proper format.

Further details on the processes that enable the various embodiments will now be provided with reference to the remaining figures.

FIG. 2A illustrates representative steps involved in the initializing process 200. In step 201, the system decodes the scripting of the actual AST which the system software provider may encode to prevent snooping or for licensing purposes. In step 202, the system loads the preset functions, which is a configuration start up file that includes the scripting subroutines or functions. These preset functions are basic required functions of the website or redundant tasks automated to provide ease of blueprint development. In this step, the system loads the basic functions into the site at initialization. An example is a pop up window function. In step 207, the system loads application variables from the database. This loading consists of Global variables which typically remain constant throughout the website display so as to eliminate re-loading unnecessary information, such as is the identity of the mail server, formatting, registration number, mail format, database type, etc. In step 216, the system identifies database locations and queries the connection to verify existence. In step 219, the system determines the type of a database being accessed. This is accomplished by reading a database field that indicates the type of database to be used by the website, such as SQL. In step 220, the system builds out the connection to the SQL string based upon the database type. The system knows the different requirements of the various databases that may be employed and builds out a string accordingly.

In step 203, the system loads the website identity. The various embodiments enable the capability for a website to have multiple identities on one site which depend upon the particular URL accessed by the web visitor. This allows different websites to be completely unique yet located on the same domain. If there is just one identity associated with the website, the system pulls the identity data in step 217. If there is more than one identity on the server, then the system selects the appropriate identity to employ based upon the base URL used by visitor in step 212.

Having established the site that is to be to presented, in step 204, the system identifies the visitor. To accomplish this, the system pulls the visitor local identifier (LCID) based upon information accessible from the visitor's web browser and IP address. The LCID (“locale ID”) is a user variable that is set in the user's browser, and is a basic server variable that can be obtained. Typically, the LCID is a decimal value, such as “3081” which is the LCID for English. The system obtains the LCID when the user first contacts the website URL, which starts the initialization process. The process performed in step 218, which is not available in known website software, is based upon the domain name, the LCID and the character set used by the visitor's computer. The system creates a table in the shell which is a relational step that matches the visitor's LCID, character sets, dialects and countries. This process and data table allows the system to recommend a language and a character set to be used on the displayed website, not just a character set as available in current web development tools.

In step 205, the system identifies the country that the website owner has opted to support. The system accomplishes this by matching the LCID to a list of countries for which web page content has been developed in various languages. If the website supports more than one country, the system selects the appropriate language to use based upon visitor. Identifying the country of the web visitor allows the website to present its contents in the language and character set of the visitor. The processes necessary to localize the website to the country are then performed.

In step 214, the system generates a language menu that parses itself as a dictionary object. This menu may be formatted to display country names or corresponding flags which provide the ability to conveniently switch between languages and dialects.

In steps 213 and 215, the system assigns the language to be used which then initiates step 313 where the appropriate language card is pulled from memory to be later referenced during the parsing stage. Language cards provide translations to all non-content found on the site. An example would be “Click to Login” which is not held with the content segments.

In step 206, the system pulls out the path types to be used in the website. The path is the location of the web document identified by the current URL. The type of path identifies the location relative to the application shell's base path as earlier determined by the current location of the web visitor. Thus, based upon the path and page type, the website can present different “looks and feels” consistent with what a visitor may expect. In step 211, the system takes the path variations—menus and etc. In doing so in step 211, the system interacts with results of step 307 in which the system sets the page type. The different types of pages include administrative, component, common area, root of the site, etc.

In step 301, the system accomplishes the processes used to provide website “localization.” In this localization step, the system uses the elements, regional settings, and country/locale information to determine the proper format for presenting location-sensitive information, such as currency and date/time. For example, in step 305, the system localizes the date by accessing the date from the server, in step 308, offsetting the date/time from GMT (function) to the visitor's time zone, and then formatting the date and time in step 316 into the appropriate localize format. Another localized value is currency. The system in step 309 converts the currency, typically maintained in the system in US dollars, into the appropriate local currency amounts and formats. For example, a merchant website may offer tee-shirts, the price for which is stored in database as dollars, but when the website is accessed by a Japanese visitor, the system converts that price into Yen. This process may require a live feed to a currency table to permit frequent updates. In step 317, the system completes the process of properly formatting the converted values.

In step 302, the system presents website materials in the proper local language and dialect. In this step, the system uses data indicating the primary language of the visitor—which may be assigned by the visitor action (e.g., by clicking on an option button) or auto selected based upon LCID and other localization information—to select and load the appropriate language card in step 313. This step interprets the content into the appropriate dialect. For example, a visitor from Luxemburg may speak Luxemburgish, French or Deutsch. In step 318, the system produces the appropriate dialect. This maybe accomplished differently for unauthenticated and authenticated visitors. For unauthenticated visitors, e.g., ordinary website visitors, a language card reads out all the website text held within the site's content database, which is content dialect generated and maintained by the website owner, as well as menus, banners and boarders. For authenticated visitors, e.g., the website owner and developers, website management consoles and menus are localized with the user's dialect. This capability provides, for example, a German site manager with German management console and editing menus. Language cards create a universal tool for the site. As part of this localization process, step 312 leads into step 405 where the system builds out the page titles, content type, and skin type, all in the selected language/dialect.

In step 303, the system checks the sites registration. Each website registration comes with a site license for shell. Each application shell needs a site license to operate. This step happens after the interpreter step so, if the site lacks a current registration, the visitor can be informed that the site is invalid in the visitor's native language. To accomplish this, the site checks for validity in step 310. The Product code includes a URL, base path, expiration date of the site, and a list of the supported components, all of which is encrypted. This code can be updated by the Web Maintainer to unlock additional features of the application. If the site's license expires or the URL is determined to be incorrect in step 310, the system goes to step 313 which will generates a prompt for the license or to update the license. If the license and URL are determined to be valid in step 310, the system goes on to step 304.

In step 304, the system sets the access level for the visitor based upon the page type. If the visitor is in the root (e.g., home page) the access is fine for most visitors. However, if the accessed page is an administration site, the system will check to determine if visitor authorization is required. If not, then the page is loaded immediately. If visitor authorization is required for the page, the system will ask for authentication and jumps to the user login step 319. In making this jump to the login site, the system remembers the page URL to which the visitor were trying to go.

In step 305 load preassembly variables. This is the process by which the newly configured variables are gathered and adjusted based on identified factors for assembly.

Having completed initialization 200 and configuration 300, the system conducts the assembly process 400, which is illustrated in FIG. 3A. In the assembly process 400, the system begins building out the dictionary elements and adding in the page content. The system creates the dictionary element from the information harvested and configured in processes 200 and 300. The input to the assembly process, step 312 is the same as the output step 312 illustrated in FIG. 2B. In step 401, the system obtains information on each page as to its template, skin type, menus, etc., so that each page can have its own content. In doing so, the system uses the URL to determine the page being assembled. In step 405, the system retrieves page and skin type information for that page. The system determines whether the skin type is unique for the particular page. The look and feel for a web page is based upon template groups, which are groups of various skins and custom style sheets which are specific or a particular site. Multiple skins within a template might only have minor variations, such as varying navigation and layout. The look and feel of a site may also control the placement of content in the site. Within the system every site is assigned a template. A website owner can set an individual page to have its own “look and feel.” Thus, in step 407, the system loads out the look and feel CSS (Cascading Style Sheet), which is a standard language that allows controlling fonts, colors and sizing. Note that the input step 402 is the output 402 from step 305 on FIG. 2B, which determines whether the standard template is being used across the website. In step 403, the system loads the loads the appropriate look and feel template. Only if the web page has a unique skin, does the system not select the default look and feel template. In steps 401/405, the system loads up the content while checking to see if the page requires a unique skin. In sum, this step 403 provides the look and feel of the website.

In step 415, the system determines whether it should load a full template or perform a minimum page load. A minimum page load is performed for small windows, such as a pop up window or a window for displaying or accessing data within a confined space page. Such minimum page loads are provided for situations where only need limited structure and layout, and do not need to show whole look and feel of the site.

In the steps linked to step 401, the system gathers the data to be displayed on the site based upon the language and the URL. In step 413, the system runs pre-specified formatting on the content, and then stores it as a dictionary object. In Step 417, the system provides the interactive segments by accessing the database, based upon the language and the positioning in the page, pulling out the appropriate response to the request for an interactive segment. In step 413, the system provides the static content, while in step 417, the system provides the dynamic content.

In step 414, the system pulls out the meta data, external information and other user defined variables required for preparing the heading of the document.

In steps 405 to 419, the system prepares a menu array from the available navigation menus based upon the particular content. Once the system has loaded the content, it prepares an array which builds in the various types of navigation required. For example, the navigation may be horizontal, vertical or combined.

The language menu illustrated in step 420 receives input from step 214 of FIG. 2B (which is the same step 214 illustrated in FIG. 3A) based upon the languages that are available and language that is being used. Using that information, the system loads the language array into the dictionary in step 420. Language menus can be displayed as text or flags providing language selections for the web visitor to choose from.

In step 422, the system creates the component menus, and in step 423 the system creates any additional menus (e.g., footer, counter, etc.) that the website may employ.

In step 421, the system loads the administration menus used for performing administrative tasks on the website. An administration menu will be visible to a visitor only if the visitor is or has been authenticated as an owner. Otherwise, the administrative menus will not be shown.

Returning to step 415, when the system determines whether a full or partial page load is to be performed, there are two processing paths that may be followed in steps 410/416. If a minimum page load is to be made, the system jumps to step 404 where it begins parsing the page, thus bypassing the processes for developing menus discussed above. If a normal page load is to be made, then the system performs the processes required to load menu arrays in step 408, with the menus added to the page in step 411.

In step 404, the system loads up the preassembly variables and unique titles and on load scripts. These elements are data and scripts which do not fit into a major category.

In the parsing process 500 the system uses all of the data and scripts that have been assembled, adds in preassembly variables, and builds out the template. In other words, in the parsing process 500, the system places all elements into the template.

In step 502, the system selects a parsing process depending upon whether the page being loading is normal or minimal. It is worth noting that the test in step 502 is performed to select a parsing process (i.e., determine how to parse) which is different from the purpose of the test in step 415 which is performed to determine the content that should be assembled for the page. If a minimum page load is to be performed, then the system performs step 503 which parses in the head (step 505) and content (step 506) information only. A minimum page load inputs the CSS values with minimum graphics. For example, if the page being created is the result of the visitor clicking a “print friendly” button (a “print friendly” menu would be one of the Additional Menus 423), the system performs a minimum page load, thereby leaving out graphics and elements that may not be rendered by many printers. On the other hand, if a full template page load is to be performed, the system parses in the head (step 509), and body (step 510) and the template itself (step 511).

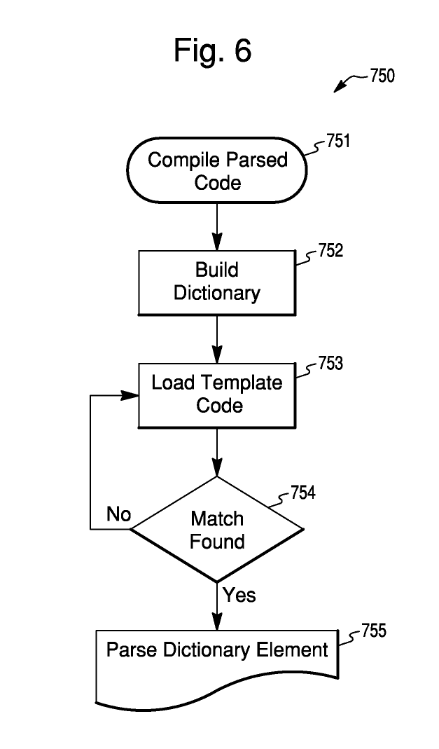

In step 507 the system compiles the parsed code. It is in this step where the system performs the various find and replace operations associated with compiling. Elements of this compilation process are illustrated FIG. 6, in which step 751 is same as step 507 of Fib. 3B.

Referring to FIG. 6, in step 752, the system identifies which data or script in a dictionary element is requested by the template for parsing. The system loads the template code in step 753 and looks through the code for the identifiers. If the system finds a match of an identifier to a dictionary element in step 754, it matches the element in step 754 to the dictionary in step 752. In accomplishing step 754, the system looks to step 752 to see whether the dictionary has the name stored within it. If it does, the system parses the matching element into the page in step 755. The system continues this process looking for more identifiers (place holders) in the template, parsing in each matching dictionary element it locates until the entire template has been scanned. This process is employed, instead of hard coding all elements directly into the web document, so the system allows templates to be designed to support all possible objects. This method allows total flexibility of repositioning the website content by loading the content in the dictionary as elements. This process also facilitates parsing in dynamic, interactive segments, which query the data source and format of the result into interactive segment dictionary elements. This enables the system to include dynamic data because the content is not immediately written to the HTML document which precludes the use of interactive elements. By implementing the content (both static and dynamic content) as dictionary items, the system has greater flexibility in terms of the location and types of content it can manage and display.

Details of the dictionary elements and inserting content are illustrated in FIG. 4. By way of reference, the processes of inserting content and menus shown in boxes 413, 414, 417 in FIG. 3A. are illustrated in more detail in FIG. 4 as process 600. User defined metadata 601 comprise key words and descriptions that website owners may specify to ensure web search engines locate the site. In step 602, the system inserts metadata required to comply with various governmental or Internet agency requirements, an example of which is Internet Content Rating Association (ICRA) compliance rating metadata. Also, metadata identifying the regional defined variables and character set are inserted in step 603. If the user is authenticated as an administrator, step 612, then the administrative management toolbar is loaded into the actions parser, step 614, so the displayed screen will include the administrator's toolbar. Other menu content, including by way of example a navigation menu 606, language menu 607, a component menu 608 and additional menus 609, are inserted into the body.

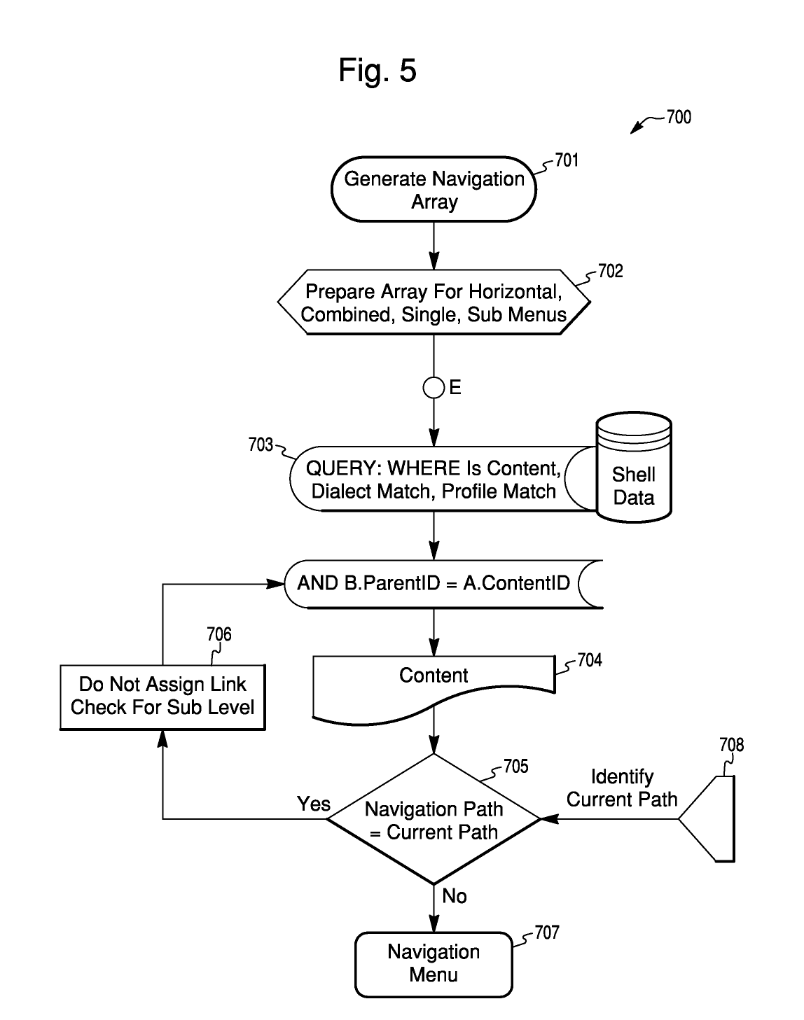

Details of the navigation array creation are illustrated as process 700 in FIG. 5. The process generates menus which identify its location at all times. Initiated in step 701, the system prepares an array menu options to provide horizontal, vertical, combined, single and submenu configurations, step 702. In step 703 the system queries the shell data to determine where the content is located on the page, as well as the content's dialect and profile to generate the associate content, step 704. In step 705, the system checks if the web visitor's current path or location is the same as in the menu, and if it is, the system checks whether the current path has any sub pages or is within a sub menu (i.e., the parent ID equals the content ID) and adjusts the formatting of the navigational menu accordingly, including not assigning a link value if the current path has any sub pages. This step avoids linking a location to itself. Then, in step 707, the system assembles the navigation menu plus submenus, and in step 708, the system pulls the current path from item 206 where the system identified the path type (as discussed above).

Referring to FIG. 3, the management processes 800 illustrates the different ways in which the system enables the website owner or developer to manage the application. The website owner has three methods of control. The methods illustrated in steps 801 and 807 are methods where the website owner is an authenticated user. The method illustrated in step 810 provides the system management access granted to a person authenticated to manage the system license or licenses to component licenses.

In step 810, the system checks to determine if a valid license exists for the website software. Every time an application is operating on a web network, such as the Internet, the system needs to have a license ID. In step 811, the system matches the license ID to a database on a central cite to confirm that it does have a current and valid license. The system may also update the software on the site if necessary. This capability permits remote management of the system license, as well as remote updating of software and database contents. The main site can query the individual licenses of functionality components and receive the version control number in step 812 to allow the system to track updates.

In step 801, after authenticating, the system provides the user with a main console containing application management 802 (which allow management of global variables) and the web identity 803, which describe the site's metadata, and look and feel. In step 804 is the structure-pages, subpages, type of menus. The system account access 805 function provides the ability to manage the people who may log into site. The components manager 806 allows the website owner to manage extended functionality, including added new components.

Integrated control 807 provides a visitor, if authenticated, with small control menus on content segments. This capability allows website owners to administer the site in the same way as a web visitor would browse the site. Segment editor 808 provides the small menus for controlling component variables and editing segments of the website. Editing while browsing is an important capability provided by the various embodiments. This enables editing regions of content while browsing, which allows viewing the site normally at the same time as changes are made. This functionality is accomplished by inserting the content into an editor which enables viewing the site at the same time as editing the site. This allows a website owner to make and review changes in real time. Administration menu 809 interfaces with the web empowerment console 801, providing short cuts to tasks provided in that counsel.

Referring to FIG. 4, the component integration process 850 provides part of the web empowerment console. The website owner or administrator has to be logged in, i.e., authenticated. This process allows checking the active components, which are those components that are already installed into the shell. In step 851, the system checks the database for active components. In step 853, the system forms the list of installed components, and error checking is performed in step 854 to confirm that the database which is required to operate is indeed available. The system will deactivate if something is missing and will send an e-mail to the website owner or primary administrator. In step 855, the system takes the list of databases passing these tests, and checks to see whether all of the friendly components have been installed. If not, in step 852, the system asks the website owner or administrator whether missing friendly components could be installed. If all friendly components are installed, then in step 856, the system tests whether the component is enabled, since and installed component may be disabled. If the component is disabled, then in step 860, the system offers the website owner or administrator an opportunity to activate it (i.e., set up the component). If this option is selected (i.e., the option to set up and enable a component), in step 861, the system prepares a component list listing all components available, installed and enabled. From that list the system builds the component menu 608 in step 862 which is a dictionary element (illustrated in FIG. 4. Note that in FIG. 8A, step 862 is equivalent to step 425 shown on FIG. 3A.

In step 852, if the component is not installed, the system allows installation of that component by contacting the regional center in step 857. When the owner or administrator clicks on install, the system talks to the regional center where a website owner can purchase a license (a process that maybe outside the system). In one embodiment, the process of purchasing a license involves receiving a code which the system employs to unlock (i.e., decrypt) the particular component, accomplished in step 858, which is already present as encrypted software within the website system. In this process, the license code unlocks the blueprint file for the desired functionality component. Specifically, in step 858, the system uses the license to unlock the blueprint, checks to see if the current version is loaded on the system by checking the version number against the latest version number posted on a central site. If the system determines that it does not have the latest version of the blueprint, the system may request an update of the blueprint from the regional center. Then in step 859, the system uses the blueprint to perform the SQL builds necessary to build out the associated database and the file system objects (FSO) to build out the directories and file names associated with the newly licensed functionality.

Processes 870 enable the setup and use of “plug and play” functional components 4. Step 871 is loosely linked to step 860 and directly linked to step 861, i.e., receives variables from step 861, in that if the component is not enabled its implementation begins with step 871. In step 871, the system tests whether the component needs to be set up. If the component needs to be set up, the system runs the process of step 874 in which the system connects to the web empowerment console where the system builds the backend administrative control elements. With those control elements built, in step 876, the system then allows the owner or administrator to modify the associate data (i.e., allows entering of data and stores the information). Optionally, in step 877, the system allows the owner or administrator to build out a user query in a customized manner. Then, the system performs step 880 which allows the owner or developer to view the live component.

Having set up and installed components, in step 872, the system then checks for like-friendly components. This is accomplished in step 875, by the system running through a cycle of checking whether there is element compatibility among installed components and enabling other components to know that the new component has been installed. In step 878, the system tests whether a particular component is compatible. If no friendly component resources are installed, the system uses single component resources in step 882 (i.e., the resources provided as part of that particular component). If at least one friendly component resource is installed, the system uses multiple component resources 881, i.e., the particular resource, or element functionality, is drawn from one of the installed friendly components. Multiple component resource 881 capability is accomplished by means of a hierarchy that ranks the friendly resources based upon various aspects of the components, so that each component can determine which of the various friendly resources it will use. This hierarchy is built into the database, such as a data element listed in the MUX table. Resources may be, for example, like the mailing list database built into both the newsletter and CRM components discussed in the example above. In that example, the CRM component has an expansive database, so it is indicated to supersede the limited subscriber list database of the newsletter component. In most cases, shareable resources are databases, but this is not the limit of options. Some menu elements may be shares, so components can operate friendly pieces through friendly menus.

The foregoing embodiments may be implemented on any number of computer systems known in the Internet computer arts. An example system 900 is illustrated in FIG. 5. A implementation of the various embodiments may be in the form of software loaded on a server system 910, which is a computer containing one or more processors, memory and one or more communication modules for interfacing with a network, such as the Internet 940. The server system 910 will typically be coupled to a database 920, which may be any storage device, such as a high capacity magnetic disc drive. An installation may also include a computer 930 coupled to the server system 910 that is configured as a user interface for locally managing the website. Alternatively, website management may be conducted via any computer 950 connecting to the server system 910 via the web, such as the Internet. A visitor may access the website using a computer 950 via the internet 940 by entering a URL that addresses the server system 910.

The various embodiments encompass the method steps described herein and illustrated in the figures, software instructions implementing the method steps, machine readable storage media (e.g., for compact disc, DVD disc, floppy disc or hard disc) on which such software instructions are stored, and systems, such as illustrated in FIG. 5, implementing the methods steps.

The foregoing description of various embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated.

I claim:

1. A web application executable at a network computer node to produce a website page, the web application comprising:
a content module including at least one main segment content;
an additional functionality module including at least one functionality component;
a dictionary module comprising library elements including one or more of a navigation menu, a language menu, an administrative menu, a content menu, and an interface string providing interfacing elements for the at least one functionality component; and
an application shell comprising software instructions for performing the steps of
initializing variables necessary to assemble the website page,
configuring the website page,
assembling content feeds using the initialized variables, and
parsing-in the content feeds from the content module, library elements from the dictionary module, and a functionality component to generate an ASP document.

2. The web application of claim 1, wherein:
the application shell software instructions further perform a step of generating HTML code that will provide the website page; and
the steps of initializing variables, configuring the website page, assembling content, parsing-in the content feeds and generating HTML code are performed at a time when the website page is accessed by a user via a network.

3. The web application of claim 2, wherein a content feed provides dynamic content such that the content displayed on the website page is determined at the time the website page is accessed by the user.

4. The web application of claim 2, wherein the application shell software instructions perform the further steps of:
receiving a location identifier from a user's web browser; and
determining content to be displayed on the website page based upon the location identifier.

5. The web application of claim 3, wherein the application shell software instructions perform the further steps of selecting a language to display on the website page based upon the received location identifier, wherein the step of determining content to be displayed on the website page is further based upon the selected language.

6. The web application of claim 1, further comprising a web empowerment module including one or more of:
a web development console;
an integrated control module; and
an application management module.

7. The web application of claim 6, wherein:
the application shell software instructions further perform a step of generating HTML code that will provide the website page; and
the web empowerment module includes software instructions for performing the steps of:
accepting a change to the website page from a user interface;
revising content elements to be displayed in the website page responsive to the accepted change to the website page; and
causing the application shell software to repeat the steps of initializing variables, configuring the website page, assembling content, parsing-in the content feeds and generating HTML code.

8. A machine readable storage medium having stored thereon software instructions for a web application, comprising:
a content module including at least one main segment content;
an additional functionality module including at least one functionality component;
a dictionary module comprising library elements including one or more of a navigation menu, a language menu, an administrative menu, a content menu, and an interface string providing interfacing elements for the at least one functionality component; and
an application shell including software instructions for performing the steps of:
initializing variables necessary to assemble a web page;
configuring the web page;
assembling content feeds using the initialized variables; and
parsing-in the content feeds from the content module, library elements from the dictionary module, and a functionality component to generate an ASP document.

9. The machine readable storage medium of claim 8, wherein the application shell further includes software instructions for generating HTML code that will provide the web page; and
the steps of initializing variables, configuring the web page, assembling content, parsing-in the content feeds and generating HTML code are configured to be performed at a time when the website page is accessed by a user via a network.

10. The machine readable storage medium of claim 9, wherein the application shell further includes software instructions for receiving a location identifier from a user's web browser, and determining content to be displayed on the website page based upon the location identifier.

11. The machine readable storage medium of claim 9, wherein the web application further comprises a web empowerment module which includes software instructions for performing the steps of:
accepting a change to the website page from a user interface;
revising content elements to be displayed in the website page responsive to the accepted change to the website page; and
causing the application shell software to repeat the steps of initializing variables, configuring the website page, assembling content, parsing-in the content feeds and generating HTML code.

12. A system, comprising a server system coupled to a network, the server having stored thereon software instructions for a web application comprising:
a content module including at least one main segment content;
an additional functionality module including at least one functionality component;
a dictionary module comprising library elements including one or more of a navigation menu, a language menu, an administrative menu, a content menu, and an interface string providing interfacing elements for the at least one functionality component; and
an application shell including software instructions for performing the steps of:
initializing variables necessary to assemble a web page;
configuring the web page;
assembling content feeds using the initialized variables; and
parsing-in the content feeds from the content module, library elements from the dictionary module, and a functionality component to generate an ASP document.

13. The system of claim 12, wherein:
the application shell further includes software instructions for generating HTML code that will provide the web page; and
the steps of initializing variables, configuring the web page, assembling content, parsing-in the content feeds and generating HTML code are configured to be performed at a time when the website page is accessed by a user via the network.

14. The system of claim 12, wherein the application shell further includes software instructions for receiving a location identifier from a user's web browser, and determining content to be displayed on the website page based upon the location identifier.

15. The system of claim 13, wherein the web application further comprises a web empowerment module which includes software instructions for performing the steps of:
accepting a change to the website page from a user interface;
revising content elements to be displayed in the website page responsive to the accepted change to the website page; and
causing the application shell software to repeat the steps of initializing variables, configuring the website page, assembling content, parsing-in the content feeds and generating HTML code.

16. A method for providing a website page accessible by a visitor via a web browser, comprising:
loading content elements into a database, each content element being associated with a content identifier;
determining content elements to be displayed in the website page and indicating that content with one or more content identifiers within a template for the website;
generating HTML code for providing the website page by parsing in content from the database in place of content identifiers in the code.

17. The method of claim 16, wherein the steps of determining content element to be displayed and generating HTML code are performed at a time when the website page is accessed by the visitor.

18. The method of claim 17, wherein a content element provides dynamic content such that the content displayed on the website page is determined at the time the website page is accessed by the visitor.

19. The method of claim 17, further comprising:
receiving a location identifier from the visitor's web browser;
selecting a language to display on the website based upon the received location identifier; and
determining content to be displayed on the website page based upon the location identifier and selected language.

20. The method of claim 16, further comprising:
accepting a change to the website from a user interface;
revising content elements to be displayed in the website responsive to the accepted change to the website; and
repeating the step of generating HTML code.
